(19) United States
(12) Patent Application Publication
(10) Pub. No.: US 2025/0071453 A1
(43) Pub. Date: Feb. 27, 2025

(54) ALLOCATING UPSTREAM RESOURCES IN AN OPTICAL NETWORK

(71) Applicant: ADTRAN GMBH, Berlin (DE)

(72) Inventor: Martin Kuipers, Dallgow-Dobertiz (DE)

(21) Appl. No.: 18/841,918

(22) PCT Filed: Mar. 16, 2022
(86) PCT No.: PCT/EP2022/056873

§ 371 Date: Aug. 27, 2024

(51) Int. Cl. H04Q 11/00

(52) U.S. Cl. CPC H04Q 11/0067; H04Q 2011/0084; H04Q 2011/0086

(57) ABSTRACT

Examples described herein in particular refer to solutions for adjusting allocations for upstream transmissions of optical network terminals comprising the step of: generating an optimized allocation for upstream transmissions of optical network terminals utilizing a first transmission system and optical network terminals utilizing a second transmission system.

### CROSS REFERENCE TO RELATED APPLICATIONS

This application is a National Stage application under 35 U.S.C. § 371 of International Application No. PCT/EP2022/056873, having an International Filing Date of Mar. 16, 2022. The disclosure of the prior application is considered part of the disclosure of this application, and is incorporated by reference in its entirety into this application.

### BACKGROUND

This specification relates to allocating upstream resources in an optical network. Example optical networks include a Gigabit Passive Optical Network (“GPON”) and a Ten Gigabit Symmetrical PON (“XGS-PON”). A GPON can use an upstream wavelength range of 1290 nm to 1330 nm and an XG(S)-PON uses an upstream wavelength range from 1260 nm to 1280 nm. However, other wavelengths may be applicable in other use cases.

### SUMMARY

Examples described herein refer to a reduction of a detrimental impact of out-of-band noise between PON systems, e.g., from XG(S)-PON ONTs that disturb a reception of a G-PON upstream transmission at the OLT.

It is an objective of this application to improve existing solutions. This objective is reached according to the features of the independent claims. Further embodiments result from the dependent claims.

The examples suggested herein may in particular be based on at least one of the following solutions. In particular, combinations of the following features could be utilized in order to reach a desired result. The features of the method could be combined with any feature(s) of the device, apparatus or system or vice versa.

A method is suggested for adjusting allocations for upstream transmissions of optical network terminals, the method comprising:
generating an optimized allocation for upstream transmissions of optical network terminals utilizing a first transmission system and optical network terminals utilizing a second transmission system.

The solution described herein in particular allows a reduction of out-of-band crosstalk in a passive optical network by optimizing the allocation of upstream resources.

According to an embodiment, the first transmission system and the second transmission system are PON systems, wherein the second transmission system allows for a higher per-channel speed than the first transmission system.

The first transmission system may be a GPON system and the second transmission system may be a 10-GPON system or any system allowing for a higher per-channel speed, e.g., 25-GPON. The second transmission system may provide a symmetrical data transmission rate, indicated by the letter “S”.

According to an embodiment, the generation of the optimized allocation comprises setting the allocation pursuant to a predetermined algorithm.

According to an embodiment, the method further comprises:
transmitting the optimized allocation as bandwidth maps from an optical line terminal or an optical network unit via a downstream frame, wherein each of the transmission system utilizes a different bandwidth map.

According to an embodiment, an optimized allocation utilizes several subsequent bandwidth maps that are transmitted in particular via subsequent downstream frames.

According to an embodiment, the generation of the optimized allocation comprises:
determining a value that is based on an OSNR degradation:
determine whether the value meets a predefined requirement:
if the value does not meet the predefined requirement, determine the optimized allocation according to a predetermined algorithm:
if the value meets the predefined requirement, continue by transmitting the optimized allocation as bandwidth maps from an optical line terminal or an optical network unit via a downstream frame.

According to an embodiment, determining the value that is based on the OSNR degradation comprises:
calculating the OSNR degradation based on at least one of the following:
   a transmission power of the respective optical network terminal,
   an optical path loss, and
   an out-of-channel crosstalk at the optical network terminal.

According to an embodiment, determining the value that is based on the OSNR degradation comprises:
calculating a differential path loss based on at least one of the following:
   a transmission power of the respective optical network terminal,
   a predetermined threshold,
   an out-of-channel crosstalk at the optical network terminal or a predetermined out-of-channel noise.

It is noted that a minimum or a low value for the transmission power can be used to determine the differential path loss.

According to an embodiment, the predetermined algorithm comprises at least one of the following steps:
filling the optimized allocation starting with optical line terminals ordered by their respective optical path loss, either in an order of increasing optical path loss or in an order of decreasing optical path loss:
filling the optimized allocation starting with the optical line terminals of the first transmission system or starting with the optical line terminals of the second transmission system:
filling the optimized allocation such that an optical line terminal chosen for an allocation does not deteriorate an OSNR beyond a predetermined value:
filling the optimized allocation by reshuffling and/or resorting a previously provided allocation.

Also, a device is suggested for adjusting allocations for upstream transmissions of optical network terminals, comprising a processing unit that is arranged to conduct the steps of the method as described herein.

The processing unit can comprise at least one, in particular several means that are arranged to execute the steps of the method described herein. The means may be logically or physically separated: in particular several logically separate means could be combined in at least one physical unit. The processing unit may comprise at least one of the following: a processor, a microcontroller, a hard-wired circuit, an ASIC, an FPGA, a logic device.

According to an embodiment, the device is or is part of an optical line terminal or an optical network unit.

Further, a computer program product is provided, which is directly loadable into a memory of a digital processing device, comprising software code portions for performing the steps of the method as described herein.

Details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an OLT, comprising a GPON system and an XGS-PON system, connected via an optical fiber to a GPON ONT and an XGS-PON ONT.

FIG. 2 shows an example of a GTC downstream frame as it is defined in the GPON recommendation G.984.3.

FIG. 3 shows a flowchart with steps that illustrate how the BWmap at the OLT can be filled thereby defining the allocation of the upstream traffic that will be transmitted by the ONTs:

FIG. 4 shows a flowchart based on FIG.3 with an added loop that allows for a re-allocation of the BWmap thereby further reducing OSNR degradation for upstream traffic originating from ONTs.

FIG. 5 shows different BWmap setting resulting in upstream allocations and their respective impact in comparison to the threshold TOSNR.

FIG. 6 shows an example of different BWmap settings for subsequent frames of the GPON system and the XGS-PON system.

### DETAILED DESCRIPTION

Solutions described herein in particular refer to a reduction of an impact of out-of-band noise from XG(S)-PON ONTs that disturb a reception of G-PON upstream transmission at the OLT.

Standard-compliant XG(S)-PON ONTs may generate out-of-band noise affecting GPON upstream reception in high differential loss co-existence scenarios. For example, a GPON uses an upstream wavelength range of 1290 nm to 1330 nm and an XG(S)-PON uses an upstream wavelength range from 1260 nm to 1280 nm. However, other wavelengths may be applicable in other use cases.

While multiple-wavelength PON systems, like NG-PON2, specify an out of band power spectral density of the transmitter with stringent requirements to an out-of-channel optical PSD at the wavelength of the different channels (e.g., G.989.2 clause 9.3.9 and 11.1.4.3), this is not the case for XG(S)-PON. Instead, XG(S)-PON only specifies a side mode suppression ratio (SMSR), which is defined as the ratio of the power of the largest peak of the transmitter spectrum to that of the second largest peak. The second largest peak, however, may be next to the main peak or it may be far away from the main peak. Both recommendations (G.9807.1 and G.987.2) specify an SMSR of 30 dB. Compared to the out-of-channel optical PSD requirements of G.989.2, this is significantly less stringent.

In case of a high differential loss on the same ODN between the GPON system and the XG(S)-PON system (e.g., in case the GPON ONT is arranged on a long fiber and/or high splitting factor and the XG(S)-PON ONT is arranged on a short fiber and/or low splitting factor) and in case both ONTs conduct upstream transmission at the same time, the OSNR (optical signal-to-noise ratio) is significantly reduced.

The following calculation shows an exemplary assumption to illustrate such OSNR reduction:

In a coexistence scenario with a GPON system and an XGS-PON system and a N1/B+ ODN class, the maximum path loss amounts to 29 dB and the minimum mean launched power of a GPON ONT amounts to 0.5 dBm. This results in an optical power level at an OLT (e.g., ONU, MPM OLT receiver) of

$$0. 5 d B m - 29 dB = - 28.5 d B m .$$

For the crosstalk from the XGS-PON ONT a minimum path loss of 14 dB and a maximum mean upstream launch power of 9 dBm are assumed. Taking the SMSR requirement of 30 dB into account, this results in a crosstalk level of up to

$$9 d B m - 14 dB - 30 dB = - 35 d B m .$$

Without additional measures, the OSNR at the OLT can be as low as

$$- 28.5 d B m - ( - 35 d B m ) = 6.5 dB ,$$

which makes an error-free reception (nearly) impossible.

The above scenario is based on worst case assumptions, but even with a lower differential path loss, the OSNR reduction may deteriorate the reception.

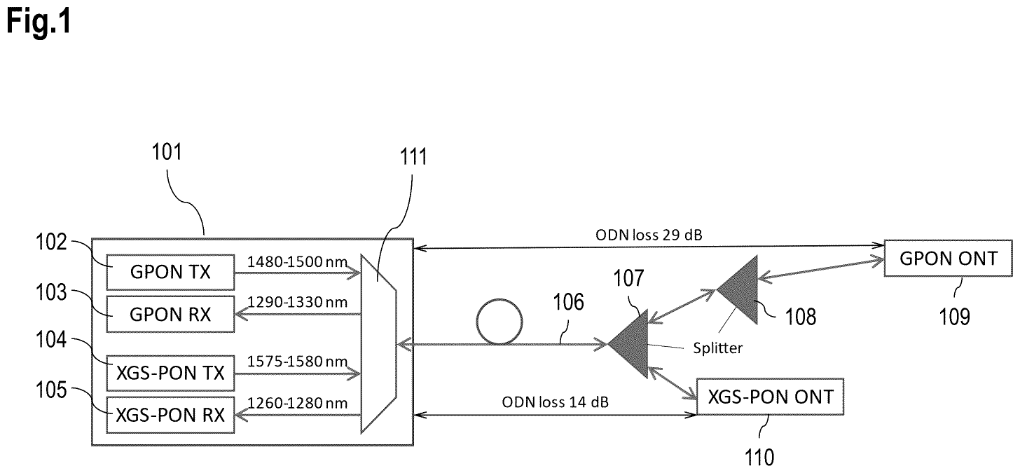

FIG. 1 shows an OLT 101 comprising a GPON system and an XGS-PON system. The GPON system comprises a transmitter 102 and a receiver 103 and the XGS-PON system comprises a transmitter 104 and a receiver 105. A fiber 106 is connected to a WDM filter 111 of the OLT 101. The WDM filter combines or isolates the wavelengths of the GPON system and the XGS-PON system for upstream and downstream.

The fiber 106 is connected via splitters 107 and 108 to ONTs, i.e., a GPON ONT 109 and an XGS-PON ONT 110.

In the example shown in FIG. 1, the GPON transmitter 102 uses a wavelength band between 1480 nm and 1500 nm, the GPON receiver 103 uses a wavelength band between 1290 nm and 1330 nm, the XGS-PON transmitter 104 uses a wavelength band between 1575 nm and 1580 nm and the XGS-PON receiver 105 uses a wavelength band between 1260 nm and 1280 nm.

A loss of the optical distribution network (ODN loss) between the OLT 101 and the GPON ONT 109 may amount to 29 dB and an ODN loss between the OLT 101 and the XGS-PON ONT 110 may amount to 14 dB.

Examples described herein avoid simultaneous transmissions of an XGS-PON ONT and a GPON ONT that would otherwise result in a high differential optical path loss and an inacceptable deterioration of the OSNR.

In the GPON system and the XGS-PON system the OLT of the respective system provides media access control for the upstream traffic. Hence, the ONTs are only allowed transmitting at specific times when transmission is granted by the OLT. In the basic concept, each downstream PHY frame or GTC frame (with a duration of 125 μs) contains a bandwidth map (BWmap) that indicates an allocation for an upstream transmission by each ONT in the corresponding upstream PHY frame or GTC frame.

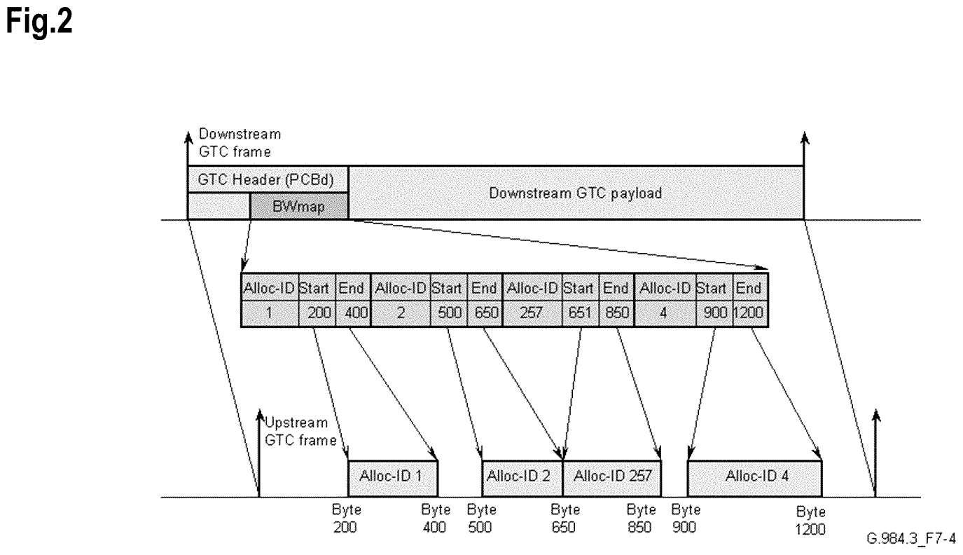

FIG.2 shows an example of a GTC downstream frame as it is defined in the GPON recommendation G.984.3. A GTC header comprises the BWmap, which defines an upstream allocation. Hence, the OLT via the downstream GTC frame defines the allocations of the upstream traffic sent by each of the ONTs towards the OLT.

This grant mechanism of the allocations can be used to coordinate the transmission of the GPON ONTs and the XG(S)-PON ONTs with potential high differential loss. For example, the transmissions of XG(S)-PON ONTs with low ODN loss and a GPON

ONT with high ODN loss can be scheduled to different time intervals during the upstream transmission frame. However, any simultaneous transmission may not be an issue in case the differential loss does not exceed a certain threshold.

The only point in time when the OLT does not know the identification and/or properties on the transmitting ONT is during the serial number acquisition/ONU discovery phase and ranging phase. These phases are rather short and occur only during the activation of the ONT. The solution is to not grant any upstream transmission for the XGS-PON system during the grants for serial number acquisition and ranging of GPON ONTs. This may also apply for XGS-PON activation to avoid possible crosstalk from GPON ONTs. These periods of silence can be used by the transceiver to measure the crosstalk from the other system at the OLT.

If the crosstalk cannot be measured directly, it can be estimated as follows: GPON and XG(S)-PON OLTs and ONTs have the capability to measure the optical transmit and receive power. The difference between receive and transmit power provides an optical path loss (OPL). The measurements for upstream and downstream can be combined (e.g., averaged) to increase the accuracy of the estimated OPL:

$$O P L = \frac{1}{2} \cdot [ ( {P}_{T X , O L T} - {P}_{R X , O N T} ) + ( {P}_{T X , O N T} - {P}_{R X , O L T} ) ] ,$$

wherein
P_{TX,OLT} is the transmit power of the OLT,
P_{RX,OLT} is the receive power at the OLT,
P_{TX,ONT} is the transmit power of the ONT, and
P_{RX,ONT} is the receive power at the ONT.

The OPL may be different for the upstream and downstream wavelengths. However, this difference is usually small compared to measurement inaccuracies and it may in particular be neglected.

Once the OPL is known, the crosstalk at the OLT can be calculated from an out-of-channel noise P_{OOC} of the XG(S)-PON ONT in the GPON upstream band. The P_{OOC} depends on the type of ONT and it is a function of its transmit power P_{TX,ONT}:

$${P}_{OOC} = {f}_{OOC} ( {P}_{T X , O N T} ) .$$

The P_{OOC} may be approximated by a constant C_{OOC}, i.e.

$${P}_{OOC , O N T} \approx {C}_{OOC} \cdot {P}_{T X , O N T} .$$

The function f_{OOC} and/or the constant C_{OOC} may be retrieved from previous measurements, e.g., lab measurements, of different ONT types. The out-of-channel noise (crosstalk) at the OLT results in:

$${P}_{O O C , O L T} = {P}_{O O C , O N T} - O P L .$$

The OSNR due to specific XG(S)-PON noise for a GPON upstream reception can be determined as follows:

$$OSN {R}_{G} = {P}_{T X , O N T , G} - {OPL}_{G} - {P}_{O O C , O L T} ,$$

wherein the index “G” refers to the GPON system. This specific OSNR_{G} shall not be lower than a pre-determined threshold T_{OSNR}, e.g., 30 dB:

$$OSN {R}_{G} \geq {T}_{O S N R}$$

$${P}_{T X , O N T , G} - O P {L}_{G} - {P}_{O O C , O L T} \geq {T}_{O S N R}$$

As mentioned above, depending on the capabilities of the GPON receiver at the OLT, it may also be feasible to measure the out-of-channel crosstalk Pooc,OLT at the OLT during silent periods of the GPON upstream signal.

### Optimizing the Bandwidth map (BWmap)

During scheduling of upstream transmission and creation of the BWmap for the next PHY and GTC frames of the GPON system and the XG(S)-PON system, any simultaneous transmission of XG(S)-PON ONTs and GPON ONTs can be planned. An optimization can be conducted such that any combination of ONT transmissions that result in an OSNR_{G} that reaches or falls below the threshold T_{OSNR} is avoided. This can be achieved via at least one of the following approaches:
Fill the BWmap of both systems starting with the ONTs with low OPL towards high OPL, or vice versa.
First, fill the BWmap of the GPON system, then fill the BWmap of the XG(S)-PON system and ensure that all grants for the XG(S)-PON system will not deteriorate the OSN R_{G} so that it reaches (or falls below) the threshold T_{OSNR}.
Fill the BWmap of both systems in the usual way and check afterwards if a problematic combination exists.

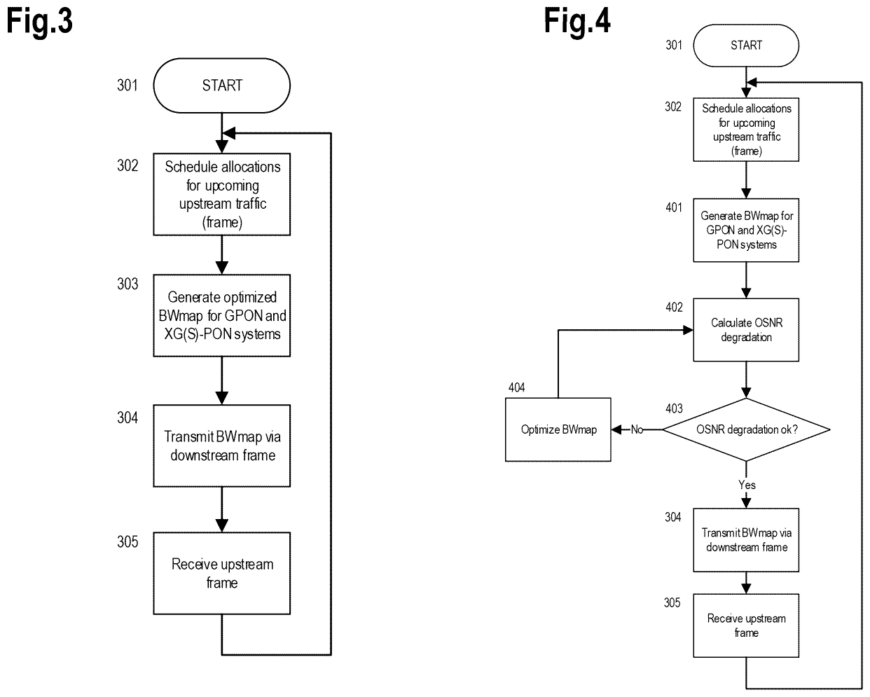

FIG. 3 shows a flowchart with steps that illustrate how the BWmap at the OLT can be filled thereby defining the allocation of the upstream traffic that will be transmitted by the ONTs.

After a start 301, in a step 302, the allocation for the upcoming upstream frames is scheduled. Next, in a step 303, an optimized BWmap is generated for at least one GPON system and for at least one XG(S)-PON system such that an OSNR degradation for upstream ONTs is reduced. As an option, the step 303 may be divided into a step that generates the BWmap for at least one GPON system and for at least one XG(S)-PON system and a subsequent step of optimizing the BWmap such that an OSNR degradation for upstream ONTs is reduced.

Next, in a step 304, the BWmap is transmitted downstream towards the ONTs of the GPON system and the XG(S)-PON system.

In a step 305, the upstream frame is received and it is branched off to step 302.

FIG. 4 shows a flowchart based on FIG.3 with an added loop that allows for a re-allocation of the BWmap thereby further reducing OSNR degradation for upstream traffic originating from ONTs. Hence, the step 303 of FIG. 3 is replaced by steps 401 to 404.

Subsequent to step 302, in a step 401, the BWmap is generated for at least one GPON system and for at least one XG(S)-PON system. Usually, a BWmap may be transmitted per optical transmission system, i.e., for the GPON system as well as for the XG(S)-PON system. In addition, the BWmap is transmitted per frame: hence, subsequent frames may comprise different BWmap settings.

In a subsequent step 402, an OSNR degradation is determined. This can be achieved, e.g., by calculating the OSNR degradation and/or by calculating a differential OPL.

In a next step 403, it is determined whether the OSNR degradation is within a predetermined range or limit, i.e., if the OSNR is acceptable. For example, the OSNR can be compared with a threshold, e.g., the threshold T_{OSNR} as described above. As an alternative (or in addition), it may be determined whether the differential OPL exceeds a predefined limit. An approach to determine a differential OPL is described below.

If the OSNR degradation is not significant, it is continued with the step 304.

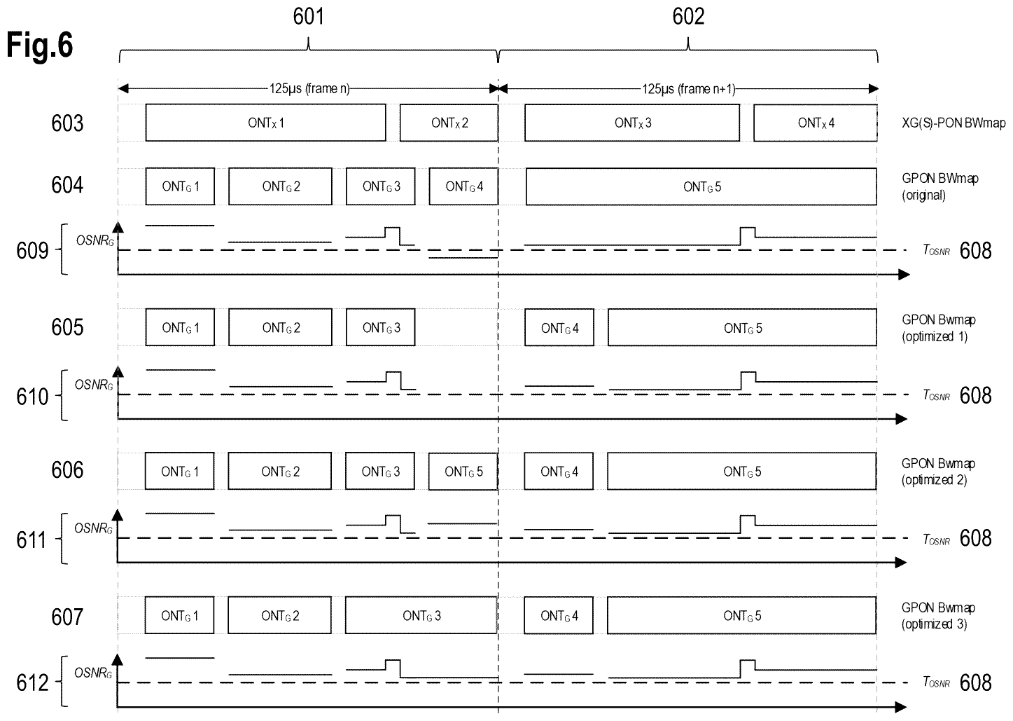

Otherwise, if the OSNR degradation is too high, the BWmap is optimized in a step 404. Such optimization may be conducted by reshuffling the allocation of the BWmap for the at least one GPON system and the at least one XG(S)-PON system. The reshuffling may at least partially introduce an arbitrary re-allocation or it may (at least in part) be based on a predefined algorithm that re-arranges the ONT allocations as described above with regard to the exemplary fillings of the BWmap. The BWmap allocation may differ between frames. In other words, several (subsequent) frames can be utilized for ONT allocations as will be exemplarily shown in FIG.6.

Subsequent to step 404 is step 402.

### Differential OPL

In case the XG(S)-PON ONTs in the network have the same properties, a requirement for a differential OPL may be determined as follows:

$$O P {L}_{G} - O P {L}_{X} \leq {P}_{T X , O N T , G} - {T}_{OSNR} - {P}_{O O C , O N T} ,$$

wherein the index “X” refers to the XG(S)-PON system.

If various XG(S)-PON ONTs with different levels of out-of-channel noise are used in the network, an upper limit of the out-of-channel noise of all ONTs

$${P}_{OOC , ONT}^{max} = max ( {P}_{OOC , O N {T}_{i}} ) ∀ {ONT}_{i}$$

may be used as a worst case assumption. In this case, the differential pathloss amounts to

$$O P {L}_{G} - O P {L}_{X} \leq {P}_{T X , O N T , G} - {T}_{OSNR} - {P}_{OOC , ONT}^{max} .$$

As an option, another worst case assumption may be a minimum transmit power of the ONT or lower limit defined by the GPON Recommendation, i.e.

$${P}_{TX , ONT , G}^{min} = min ( {P}_{T X , O N {T}_{i} , G} ) ∀ {ONT}_{i} .$$

Then, the differential pathloss might even become independent from individual ONT characteristics:

$$O P {L}_{G} - O P {L}_{X} \leq {P}_{TX , ONT , G}^{min} - {T}_{OSNR} - {P}_{OOC , ONT}^{max} .$$

### Exemplary Allocations Due to Different BWmaps

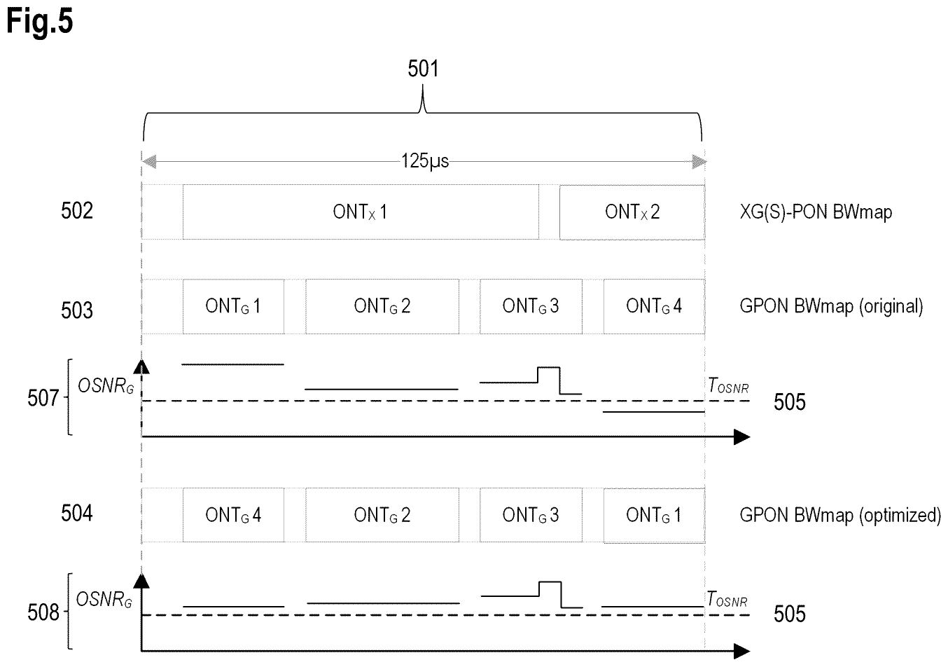

FIG.5 shows different BWmap settings resulting in upstream allocations and their respective impact in comparison to the threshold T_{OSNR}.

An upstream frame 501 in this example has a duration of 125 μs. The allocations for the GPON and XG(S)-PON system visualized in FIG. 5 are the result of the two BWmaps conveyed from the OLT via the downstream frames of FIG. 2. Each allocation of GPON ONTs and XG(S)-PON ONTs may thus be conveyed via a single BWmap.

FIG. 5 shows two different exemplary allocations: A first BWmap setting results in allocations 502 and 503 and a second (optimized) BWmap setting results in allocations 502 and 504.

First BWmap setting:

The BWmaps conveyed by the OLT result in
the XG(S)-PON allocation 502 comprising an allocation for two XG(S)-PON ONTs: ONTx1 and ONTx2; and
the GPON allocation 503 comprising an allocation for four GPON ONTs: ONT_{G}1, ONT_{G}2, ONT_{G}3and ONT_{G}4.

In this example ONTₓ1 overlaps with ONT_{G}1, ONT_{G}2 and (partially) ONT_{G}3 and ONT_{X}2 overlaps with (partially) ONT_{G}3 and ONT_{G}4.

These overlaps result in OSNR_{G} values as indicated in a diagram 507: The overlap between ONT_{X}2 and the ONT_{G}4 falls below a threshold T_{OSNR} 505, which may be too low for an error-free reception at the OLT.

Second BWmap setting:

In order to avoid this, the allocations of the GPON ONTs are reshuffled such that ONT_{G}1 and ONT_{G}4 switch places. This results in
the GPON allocation 504 comprising a different allocation for the four GPON ONTs: ONT_{G}4, ONT_{G}2, ONT_{G}3 and ONT_{G}1.

Hence, ONT_{X}1 overlaps with ONT_{G}4, ONT_{G}2 and (partially) ONT_{G}3 and ONT_{X}2 overlaps with (partially) ONT_{G}3 and ONT_{G}1.

These overlaps result in OSNRG values as indicated in a diagram 508: The overlaps between GPON-ONTs and XG(S)-PON ONTs do no longer fall below the threshold T_{OSNR} 505. Hence, the degradation of the OSNR_{G} is reduced due to optimizing allocation 503 into allocation 504.

It is noted that these calculations can be conducted by the OLT, in particular in advance of the transmission of the BWmaps. In the example shown in FIG.5, the resulting XG(S)-PON BWmap remains the same, whereas the GPON BWmap is adjusted between the allocation 503 and the allocation 504 to reduce the OSNR_{G} degradation for upstream ONTs, i.e., for the ONT_{G}3 to the ONT_{G}4. It is also an option that the GPON

BWmap remains fixed and the XG(S)-PON BWmap is adjusted. It is another option, that both, the GPON BWmap and the XG(S)-PON BWmap, are adjusted and none is fixed.

FIG.6 shows an example of different BWmap settings for subsequent frames of the GPON system and the XGS-PON system.

Different BWmap settings result in different upstream allocations and have a different impact in relation to the threshold T_{OSNR}.

The example shown in FIG.6 utilizes two subsequent frames 601 and 602 for allocation purposes. As a result, instead of the 125 μs time interval of a single frame, twice the amount of time, i.e., 250 μs, can be used to efficiently distribute the allocations for the two PON systems.

FIG.6 shows four different exemplary allocations: A first BWmap setting results in allocations 603 and 604, a second (optimized) BWmap setting results in allocations 603 and 605, a third (optimized) BWmap setting results in allocations 603 and 606 and a fourth (optimized) BWmap setting results in allocations 603 and 607.

First BWmap setting:

The BWmaps conveyed by the OLT result in
the XG(S)-PON allocation 603 comprising an allocation for four XG(S)-PON ONTs: ONT_{X}1 to ONT_{X}4; and
the GPON allocation 604 comprising an allocation for five GPON ONTs: ONT_{G}1 to ONT_{G}5.

In this example
ONT_{X}1 overlaps with ONT_{G}1, ONTG2 and ONT_{G}3,
ONT_{X}2 overlaps with ONT_{G}3 and ONT_{G}4,
ONT_{X}3 overlaps with ONT_{G}5, and
ONT_{X}4 also overlaps with ONT_{G}5.

These overlaps result in OSNR_{G} values for the GPON system as indicated in a diagram 609: The overlap between ONT_{X}2 and the ONT_{G}4 falls below a threshold T_{OSNR} 608, which may be too low for an error-free reception at the OLT.

Second BWmap setting:

In order to avoid this, the allocations of the GPON ONTs are reshuffled while maintaining the allocations of the XG(S)-PON ONTs. As a results, in the GPON allocation 605
ONT_{X}1 overlaps with ONT_{G}1, ONT_{G}2 and ONT_{G}3,
ONT_{X}2 overlaps with ONT_{G}3,
ONT_{X}3 overlaps with ONT_{G}4 and ONT_{G}5, and
ONT_{X}4 also overlaps with ONT_{G}5.

These overlaps result in OSNR_{G} values as indicated in a diagram 610: The overlaps between GPON-ONTs and XG(S)-PON ONTs do no longer fall below the threshold T_{OSNR} 608. Hence, the degradation of the OSNR is reduced by the optimized allocation 605.

Third BWmap setting:

In this example, the allocations of the GPON ONTs are reshuffled while maintaining the allocations of the XG(S)-PON ONTs. As a results, in the GPON allocation 606
ONT_{X}1 overlaps with ONT_{G}1, ONT_{G}2 and ONT_{G}3,
ONT_{X}2 overlaps with ONT_{G}3 and ONT_{G}5,
ONT_{X}3 overlaps with ONT_{G}4 and ONT_{G}5, and
ONT_{X}4 overlaps with ONT_{G}5.

These overlaps result in OSNRG values as indicated in a diagram 611: The overlaps between GPON-ONTs and XG(S)-PON ONTs do not fall below the threshold T_{OSNR} 608.

Fourth BWmap setting:

In yet another example, the allocations of the GPON ONTs are reshuffled while maintaining the allocations of the XG(S)-PON ONTs. As a results, in the GPON allocation 607
ONT_{X}1 overlaps with ONT_{G}1, ONT_{G}2 and ONT_{G}3,
ONT_{X}2 overlaps with ONT_{G}3,
ONT_{X}3 overlaps with ONT_{G}4 and ONT_{G}5, and
ONT_{X}4 overlaps with ONT_{G}5.

These overlaps result in OSNR_{G} values as indicated in a diagram 612: The overlaps between GPON-ONTs and XG(S)-PON ONTs do not fall below the threshold T_{OSNR} 608.

The various BWmap settings in FIG.6 show different approaches to resolve the conflict of OSNR_{G} values falling below the threshold T_{OSNR} by utilizing the duration of two subsequent time frames 601 and 602. Hence, adding at least one additional frame grants additional degrees of freedom regarding the allocation of the ONTs.

In the second BWmap setting, the allocation ONT_{G}4 is shifted to the second frame 602, which results in a reduction of the bandwidth available for the allocation ONT_{G}5. Also, 5 a portion of the bandwidth in frame 601 remains unused.

In the third BWmap setting, a portion of the allocation ONT_{G}5 is moved from the frame 602 to the frame 601.

In the fourth BWmap setting, the portion of the allocation ONT_{G}3 in the frame 601 has been increased, which results in less allocations for ONT_{G}3 in frames subsequent to frame 602.

### Abbreviations

BWmap bandwidth map
GPON Gigabit PON
GTC GPON transmission convergence
MPM Multi-PON Module
NG-PON2 Next Generation PON 2
ODN Optical Distribution Network
OLT Optical Line Terminal
ONT Optical Network Terminal
ONU Optical Network Unit
OOC out-of-channel
OPL optical path loss
OSNR optical signal-to-noise ratio
PHY physical (layer)
PON Passive Optical Network
PSD physical spectral density
SMSR side mode suppression ratio
XG-PON 10-GPON
XGS-PON 10-Gigabit Symmetrical PON

1. A method for adjusting allocations for upstream transmissions of optical network terminals comprising:
generating an optimized allocation for upstream transmissions of optical network terminals utilizing a first transmission system and optical network terminals utilizing a second transmission system.

2. The method according to claim 1, wherein the first transmission system and the second transmission system are PON systems, wherein the second transmission system allows for a higher per-channel speed than the first transmission system.

3. The method according to claim 1, wherein the generation of the optimized allocation comprises setting the allocation pursuant to a predetermined algorithm.

4. The method according to claim 3, further comprising:
transmitting the optimized allocation as bandwidth maps from an optical line terminal or an optical network unit via a downstream frame, wherein each of the transmission system utilizes a different bandwidth map.

5. The method according to claim 4, wherein an optimized allocation utilizes several subsequent bandwidth maps that are transmitted in particular via subsequent downstream frames.

6. The method according to any of claims 1, wherein the generation of the optimized allocation comprises:
determining a value that is based on an OSNR degradation;
determine whether the value meets a predefined requirement;
if the value does not meet the predefined requirement, determine the optimized allocation according to a predetermined algorithm; and
if the value meets the predefined requirement, continue by transmitting the optimized allocation as bandwidth maps from an optical line terminal or an optical network unit via a downstream frame.

7. The method according to claim 6, wherein determining the value that is based on the OSNR degradation comprises:
calculating the OSNR degradation based on at least one of the following:
a transmission power of the respective optical network terminal,
an optical path loss, and
an out-of-channel crosstalk at the optical network terminal.

8. The method according to claim 6, wherein determining the value that is based on the OSNR degradation comprises:
calculating a differential path loss based on at least one of the following:
a transmission power of the respective optical network terminal, a predetermined threshold, and
an out-of-channel crosstalk at the optical network terminal or a predetermined out-of-channel noise.

9. The method according to claim 3, wherein the predetermined algorithm comprises at least one of the following steps:
filling the optimized allocation starting with optical line terminals ordered by their respective optical path loss, either in an order of increasing optical path loss or in an order of decreasing optical path loss;
filling the optimized allocation starting with the optical line terminals of the first transmission system or starting with the optical line terminals of the second transmission system;
filling the optimized allocation such that an optical line terminal chosen for an allocation does not deteriorate an OSNR beyond a predetermined value; and
filling the optimized allocation by reshuffling and/or resorting a previously provided allocation.

10. (canceled)

11. (canceled)

12. A non-transitory computer readable medium storing a computer program product directly loadable into a memory of a digital processing device, comprising software code portions that cause the digital processing device to perform steps of a method comprising:
generating an optimized allocation for upstream transmissions of optical network terminals utilizing a first transmission system and optical network terminals utilizing a second transmission system.

13. The non-transitory computer readable medium according to claim 12, wherein the first transmission system and the second transmission system are PON systems, wherein the second transmission system allows for a higher per-channel speed than the first transmission system.

14. The non-transitory computer readable medium according to claim 12, wherein the generation of the optimized allocation comprises setting the allocation pursuant to a predetermined algorithm.

15. The non-transitory computer readable medium according to claim 14, wherein the software code portions cause the digital processing deice to perform steps further comprising:
transmitting the optimized allocation as bandwidth maps from an optical line terminal or an optical network unit via a downstream frame, wherein each of the transmission system utilizes a different bandwidth map.

16. The non-transitory computer readable medium according to claim 15, wherein an optimized allocation utilizes several subsequent bandwidth maps that are transmitted in particular via subsequent downstream frames.

17. The non-transitory computer readable medium according to claim 12, wherein the generation of the optimized allocation comprises:
determining a value that is based on an OSNR degradation;
determine whether the value meets a predefined requirement;
if the value does not meet the predefined requirement, determine the optimized allocation according to a predetermined algorithm; and
if the value meets the predefined requirement, continue by transmitting the optimized allocation as bandwidth maps from an optical line terminal or an optical network unit via a downstream frame.

18. The non-transitory computer readable medium according to claim 17, wherein determining the value that is based on the OSNR degradation comprises:
calculating the OSNR degradation based on at least one of the following:
a transmission power of the respective optical network terminal,
an optical path loss, and
an out-of-channel crosstalk at the optical network terminal.

19. The non-transitory computer readable medium according to claim 17, wherein determining the value that is based on the OSNR degradation comprises:
calculating a differential path loss based on at least one of the following:
a transmission power of the respective optical network terminal, a predetermined threshold, and
an out-of-channel crosstalk at the optical network terminal or a predetermined out-of-channel noise.

20. The non-transitory computer readable medium according to claim 14, wherein the predetermined algorithm comprises at least one of the following steps:
filling the optimized allocation starting with optical line terminals ordered by their respective optical path loss, either in an order of increasing optical path loss or in an order of decreasing optical path loss;
filling the optimized allocation starting with the optical line terminals of the first transmission system or starting with the optical line terminals of the second transmission system;
filling the optimized allocation such that an optical line terminal chosen for an allocation does not deteriorate an OSNR beyond a predetermined value; and
filling the optimized allocation by reshuffling and/or resorting a previously provided allocation.

21. A device for adjusting allocations for upstream transmissions of optical network terminals, comprising a processing unit that is arranged to conduct steps of a method comprising:
generating an optimized allocation for upstream transmissions of optical network terminals utilizing a first transmission system and optical network terminals utilizing a second transmission system.

22. The device according to claim 21, wherein the device is or is part of an optical line terminal or an optical network unit.
